(19) United States
(12) Patent Application Publication
(10) Pub. No.: US 2022/0184836 A1
(43) Pub. Date: Jun. 16, 2022

(54) Food Slicer and Shredder

(71) Applicants: Cordelia Sandy, Hawthorne, CA (US); Adeyinka Hamid, Hawthorne, CA (US)

(72) Inventors: Cordelia Sandy, Hawthorne, CA (US); Adeyinka Hamid, Hawthorne, CA (US)

(21) Appl. No.: 17/541,324

(22) Filed: Dec. 3, 2021

Related U.S. Application Data
(60) Provisional application No. 63/125,052, filed on Dec. 14, 2020.

(51) Int. Cl. B26D 3/28; A47J 43/07

(52) U.S. Cl. CPC B26D 3/283; B26D 2003/287; B26D 2003/286; A47J 43/0722

(57) ABSTRACT

The present invention relates generally to the field of vegetable shredders. More specifically, the present invention relates to an improved food slicer and shredder device that enables the users to easily cut different food items such as vegetables to a desired size. The device may also include a kit comprised of a plurality of blade attachments to cut food items of different sizes, and a chute attachment that allows the users to direct sliced food items into a bowl. The device features different cutting speed options that can be easily set by the user for improved cutting. As a result, this invention offers an improved food processing tool for personal and professional kitchens, and eliminates the need to use multiple tools/devices to cut vegetables of desired size.

### CROSS-REFERENCE TO RELATED APPLICATION

The present application claims priority to, and the benefit of, U.S. Provisional Application No. 63/125,052, which was filed on Dec. 14, 2020 and is incorporated herein by reference in its entirety.

### FIELD OF THE INVENTION

The present invention relates generally to the field of vegetable shredders. More specifically, the present invention relates to an improved food slicer and shredder device that enables the users to easily cut different food items such as vegetables to a desired size. The device may also include a kit comprised of a plurality of blade attachments to cut food items of different sizes, and a chute attachment that allows the users to direct sliced food items into a bowl. The device features different cutting speed options that can be easily set by the user for improved cutting. As a result, this invention offers an improved food processing tool for personal and professional kitchens, and eliminates the need to use multiple tools/devices to cut vegetables of a desired size. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, vegetables such as okra, spinach and other greens are frequently chopped for cooking in personal and professional kitchens. Generally, people use common kitchen knives to slice said vegetables and other food items to make the vegetables ready for cooking. To cut the vegetables to a desired size, individuals may require various kinds of kitchen knives, chopping boards and other tools. To cut the vegetables, an individual typically grabs a knife with one hand and places the vegetable to be cut on a chopping board surface, then holds the vegetable in place with the other hand and then cuts the vegetable manually. This manual process of cutting vegetables and other food items takes a significant amount of time, effort and skill. Additionally, there is always a risk of getting injured while cutting vegetables using standard knives, especially if the individual is inexperienced with cutting or makes a cutting error.

Various tools such as food shredders and choppers are available in the market, that enable a user to cut vegetables quickly and without any risk of injury. However, standard food shredders and choppers require manual operation and still require significant effort on behalf of the user. Additionally, standard food shredders and processors may be unable to slice or shred foods to a desired size. However, individuals may need specific sizes of chopped vegetables to cook a certain dish, for which multiple tools and devices may be needed to slice or shred the vegetables. Further, it may be economically undesirable for a user to possess different kinds of kitchen knives or vegetable cutting devices in order to achieve the desired vegetable size.

Therefore, there exists a long-felt need in the art for a shredder device that is automatic, and does not require a user to exert manual effort while cutting vegetables or other foods. There is also a long-felt need in the art for a food slicer and shredder device that allows users to easily cut different shapes of vegetables in different sizes, as per their desires. Additionally, there is a long-felt need in the art for a food slicer that eliminates the need to use different kinds of kitchen knives and to use multiple tools/devices to achieve the desired sized sliced vegetables. Moreover, there is a long-felt need in the art for a vegetable shredder device that allows users to quickly cut the vegetables and other food items, but also prevents users from becoming cut or injured.

The subject matter disclosed and claimed herein, in one embodiment thereof, comprises a food slicing and shredding device that is configured to slice or shred vegetables or other food items. More specifically, the device has a removable top cover, a middle glass cover and a bottom housing. The top cover and middle cover can be transparent or translucent, and the housing is preferably made up of a metal or heavy-duty plastic. The removable top cover also has a feed chute for feeding food items for slicing and shredding, a dispenser chute for dispensing shredded food items and a blade attachment positioned within the top cover for slicing and shredding said food items using the horizontal blades of the blade attachment. The blade attachment is further fastened to a blade connector, wherein the blade connector is positioned at the top of a blade driving unit or shaft, extending from a bottom surface of the middle glass cover. A motor is also disposed within the housing and is configured to rotate the blade driving unit to rotate the blade attachment for slicing and shredding of the food items.

In this manner, the novel food slicer and shredder device of the present invention accomplishes all of the forgoing objectives, and provides a relatively safe, easy and convenient solution to cut food items to a desired size without using multiple tools and other devices. The food slicer and shredder device of the present invention is also user-friendly, as it prevents a user from being cut while cutting vegetables or other food. Additionally, the multiple blade attachments of the device eliminate the need to keep different knives for cutting desired sized vegetables or food. Accordingly, the food slicer and shredder device makes vegetable cutting a quick, safe and hassle-free process.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a food slicer and shredder device, wherein the device slices or shreds food items and directs the food pieces to land in a bowl. The device further comprises a removable top cover, a middle glass cover and a bottom housing. The removable top cover is further comprised of a feed chute for feeding food items for slicing and shredding, a dispenser chute for dispensing shredded food items and a blade attachment positioned within the top cover for slicing and shredding said food items using the horizontal blades of the blade attachment. The blade attachment is fastened to a blade connector, wherein the blade connector is positioned at the top of a blade driving unit or shaft extending from a bottom surface of the middle glass cover. A motor is further disposed within the housing and is configured to rotate the blade driving unit to rotate the blade attachment for slicing and shredding of the food items. A rotor portion of the motor further rotates the blade driving unit to rotate the blade attachment, wherein the motor receives electrical power from a regular alternating current power supply or an internal battery.

In a further embodiment of the present invention, a food slicer and shredder device is disclosed. The device includes a motor configured to rotate a blade attachment, wherein the blade attachment has either three or four horizontal blades, and the blade attachment is detachably attached to a blade driving unit. More specifically, the blade driving unit is coupled to a rotor of said motor at one end and the blade attachment is fastened at the other end. The horizontal blades then slice and shred the food items and dispense the items through a dispenser chute. A plurality of control buttons are disposed on the housing of the device which controls the speed of the rotor to chop the food items to different levels.

In another embodiment of the present invention, a food slicer and shredder device is disclosed. The device includes a removable top cover, a middle cover and a bottom housing, wherein the top cover has a housing to accommodate a blade unit for shredding and slicing food, as well as a dispenser chute for dispensing shredded food items and a feeding chute to receive food items for slicing and shredding. The top cover is also fastened to a middle cover that is positioned below the top cover, wherein the middle cover is comprised of a blade driving shaft configured to rotate the blade unit. Further, the bottom housing portion has an inbuilt motor to drive the driving shaft to rotate the blade unit, and also includes a plurality of control buttons to control rotation of the blade unit. In addition, the motor is powered through an electrical supply or through an inbuilt battery.

An additional embodiment of the present invention may also disclose a food item shredding device kit. The kit includes a food shredding device, a three-blade attachment, a four-blade attachment and a bowl. The attachments are configured to be removably-attached to the food shredding device, and the bowl is configured to receive shredded food items from the food-shredding device.

The invention may also disclose a method of chopping or slicing food items. The method includes: feeding a food item such as a vegetable into a food shredder device, activating the device to rotate a blade attachment having horizontal blades, controlling the rotational speed of the blade attachment using one of the plurality of control buttons disposed on the shredder device, shredding said food item using horizontal blades of the blade attachment, and dispensing shredded food items from a dispenser chute to a bowl.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a food slicer and shredder device of the present invention in accordance with the disclosed architecture;

FIG. 2 illustrates a perspective view showing a blade attachment connector of one potential embodiment of the food slicer and shredder device of the present invention in accordance with the disclosed architecture;

FIG. 3 illustrates a perspective view showing internal components of one potential embodiment of a food slicer and shredder device of the present invention in accordance with the disclosed architecture; and

FIG. 4 illustrates a perspective view showing shredding and slicing of a food item using one potential embodiment of a food slicer and shredder device of the present invention in accordance with the disclosed architecture.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a shredder device that is automatic and does not require a user to exert manual effort while cutting vegetables or other foods. There is also a long-felt need in the art for a food slicer and shredder device that allows a user to easily cut different shapes of vegetables in different sizes, as per their desires. Additionally, there is a long-felt need in the art for a food slicer that eliminates the need to use different kinds of kitchen knives and to use multiple tools/devices to achieve the desired sized sliced vegetables, and that also allows users to quickly cut the vegetables and other food items, but also prevents users from becoming cut or injured.

The present invention, in one exemplary embodiment, comprises a novel food slicer and shredder device. The device includes a removable top cover, a middle cover and a bottom housing. The top cover forms an enclosed space to accommodate a blade unit for shredding and slicing food, a dispenser chute for dispensing shredded food items and a feeding chute to receive food items for slicing and shredding. The top cover is further fastened to a middle cover that is positioned below the top cover, wherein the middle cover has a blade driving shaft configured to rotate the blade unit. The bottom housing portion further has an inbuilt motor to drive the driving shaft to rotate the blade unit, and also includes a plurality of control buttons to control rotation of the blade unit. The device is also comprised of a motor which is powered through an electrical supply or through an inbuilt battery via wired circuits.

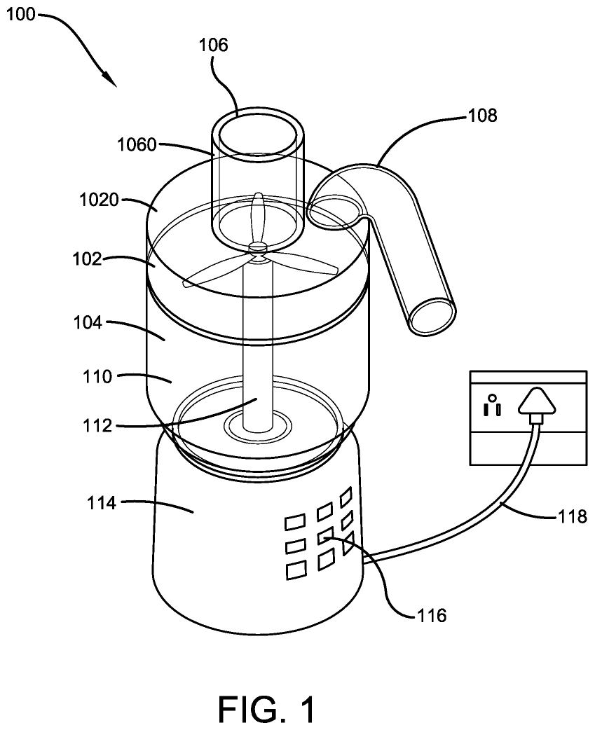

Referring initially to the drawings, FIG. 1 illustrates a perspective view of one potential embodiment of a food slicer and shredder device 100 of the present invention in accordance with the disclosed architecture. The device 100 has a removable top cover 102 that can be removed to access and change a blade attachment 104. In differing embodiments, the device 100 may have two blades attachments 104, which comprise a four-shredder blade attachment 104 and a three-shredder blade attachment 104, that are detachably-attached to the device 100 to provide a simple and convenient slicing, chopping or shredding mechanism in both personal and commercial kitchens. The removable top cover 102 has a continuous opening 106 used for inserting a food item for slicing, chopping or shredding, wherein cylindrical walls 1060 extend to create the opening 106 on the top surface 1020 of the cover 102. The cylindrical walls 1060 and the opening 106 act as a feed chute for feeding food items for slicing, chopping and shredding. The top cover 102 also has a discharge chute 108 to remove shredded food items from the top cover 102 by allowing a user to remove shredded material without removing the top cover 102 or turning the device 100 upside down. The discharge chute 108 can be provided with a cap for selectively opening and closing the chute 108.

A middle glass cover 110 is positioned below the top cover 102, wherein the top cover 102 locks to the middle glass cover 110 using a locking means that can include threads or any other suitable mechanism, such as but not limited to snap or bayonet. The middle glass cover 110 has a rotating shaft or blade driving unit 112 extending from the bottom surface of the middle glass cover 110, which engages with a motor (not shown) placed in the housing 114 of the shredder device 100, thereby allowing the motor 302 to drive the blade attachment 104 through the blade driving unit 112. The rotating shaft 112 at its top end has a blade connector allowing the blade attachment 104 to be connected to the shaft 112, and thus allowing rotation of the blade attachment 104 at a desired speed for slicing, chopping or shredding food items inserted through the opening 106. The middle glass cover 110 is also sealed with plastic walls and does not allow any air, water or debris to be inserted into the middle glass cover 110.

The housing 114 is the bottom section of the shredder device 100 and contains a motor 302, an internal battery 314, a control module 122 and a wired circuit 1180 for operation of the device 100. The housing 114 can be made up of any durable and sturdy material such as heavy-duty plastic or a metal. The housing 114 is shown with a circular sidewall, but other shapes may also be employed such as, but not limited to, a square, rectangle, hexagon, etc. The housing 114 also has a plurality of control buttons 116 allowing a user to control operations of the device 100. The speed of rotation of the blade attachment 104 can be controlled using the control buttons 116 and the device 100 can be turned ON or OFF. The housing 114 is connected with a power cord 118 that is inserted into a regular power supply to provide household electric power (alternating current) to the device 100 for operation. A rechargeable battery or batteries can also be provided within the internal battery 314 in lieu of the power cord 118, or along with the power cord 118, thereby allowing a user to operate the device 100 even when electric power is not available.

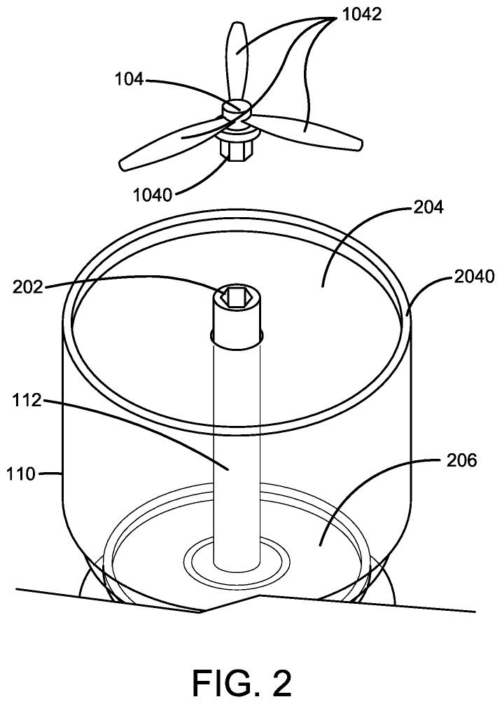

FIG. 2 illustrates a perspective view showing a blade attachment connector 202 of one potential embodiment of the food slicer and shredder device 100 of the present invention in accordance with the disclosed architecture. The middle glass cover 110 provides support for a user to hold the device 100, wherein the glass cover 110 has a base surface 206 and a top surface 204. Further, the blade driving unit 112 extends from the base surface 206 to the top surface 204, and a blade connector 202 is positioned at the top end of the blade driving unit 112 and is configured to receive the blade attachment screw 1040. The blade attachment screw 1040 is screwed into the threaded blade connector 202 for secure fastening of the blade attachment 104. When the blade attachment 104, which is comprised of a plurality of shredder blades 1042, is coupled to the blade connector 202, the rotation of the blade driving unit 112 rotates the blade attachment 104 allowing the blades 1042 to slice, chop and shred food items. A threaded locking protrusion 2040 along the periphery of the top surface 204 also allows the top cover 102 to lock with the threaded locking protrusion 2040.

Furthermore, it is preferred that the middle glass cover 110 can be made of a transparent material that is both durable and lightweight. It is also envisioned that the middle glass cover 110 can be made of a translucent or an opaque material. The blade driving unit 112 can be made of stainless steel or a lightweight material such as aluminum. The blade attachment 104 can also be made of stainless steel.

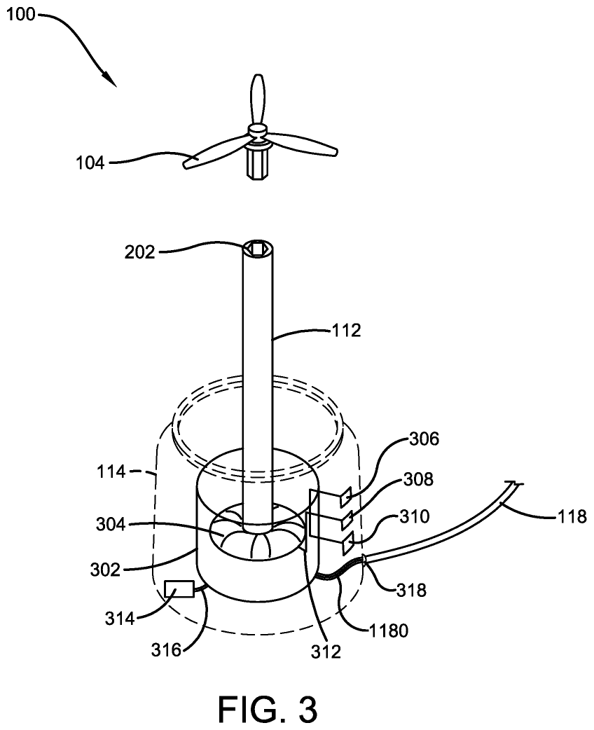

FIG. 3 illustrates a perspective view showing the internal components of one potential embodiment of a food slicer and shredder device 100 of the present invention in accordance with the disclosed architecture. The housing 114 of the food shredder device 100 has a motor 302 selectively powered by regular electrical power through a power cord 118 using an internally wired circuit 1180. Also, an internal battery 314 can power the motor 302 using a second wired circuit 316. The motor 302 has a rotor 304 to drive the blade driving unit 112 to rotate the blade attachment 104 fastened in the blade connector 202. The rotor 304 engages to the driving unit 112 and rotates the blade attachment 104 for slicing, chopping and shredding of food items.

The housing 114 comprises a plurality of control buttons 306, 308, 310 (collectively shown as 116 in FIG. 1) that are connected to the motor 302 through an internal wired circuit 312. Each control button 306, 308, 310 is configured to control the speed of the rotor 304, and thus the rotation of the blade attachment 104. One control button 306 can set the speed of the rotor 304 to the lowest speed level, another control button 308 can set the speed of the rotor 304 to a medium speed level and a final control button 310 sets the speed of the rotor 304 to the highest speed level. For switching ON and OFF the device 100, an ON/OFF button 318 connects or disconnects the power supply of both the regular supply and the battery 314 to the motor 302.

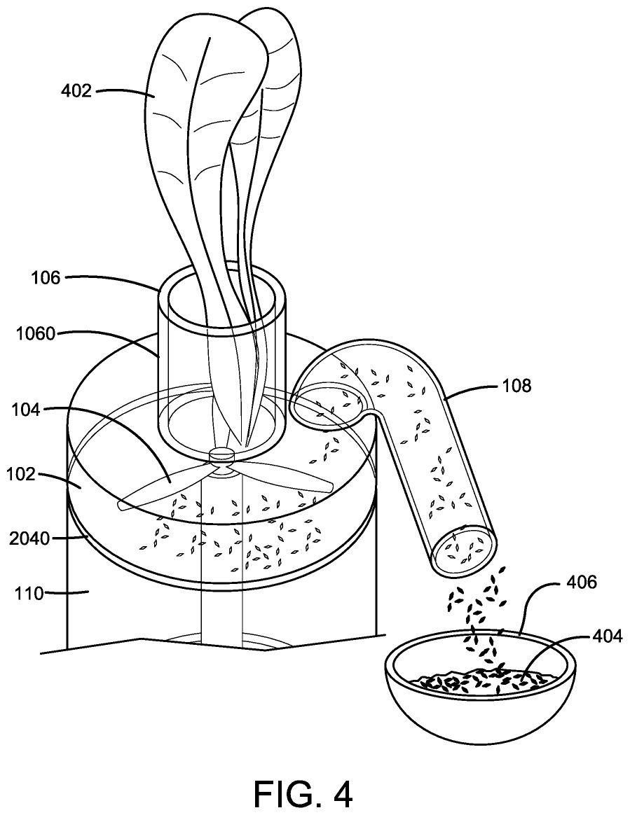

FIG. 4 illustrates a perspective view showing the shredding and slicing of a food item using one potential embodiment of a food slicer and shredder device of the present invention in accordance with the disclosed architecture. A food item 402 (such as but not limited to a vegetable) can be inserted into the top cover 102 through the opening 106, wherein the opening 106 and the cylindrical wall 1060 form the feed chute for the device 100. When the motor 302 starts, the blade attachment 104 fastened to the blade connector of the blade driving unit 112 starts rotating within the top cover 102 at a desired rotational speed. As stated earlier, during use, the top cover 102 is screwed to the middle glass cover 110 along the fastener 2040.

As the food item 402 is fed into the top cover 102, the food item 402 is sliced, shredded or chopped by the blades of the blade attachment 104. The chopped food item 404 is then dispensed through the dispenser chute 108 into a chopped food item receiver bowl 406. The shredded food item is automatically dispensed through the dispenser chute 108, and chopped food from the blades of the blade attachment 104 are forced towards the dispenser chute 108 due to the centrifugal force of the blades.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “food slicer and shredder device”, “food slicing and shredding device”, “food shredder”, “ food shredder device”, and “device”, are interchangeable and refer to the food slicer and shredder device 100 of the present invention.

Notwithstanding the forgoing, the food slicer and shredder device 100 of the present invention can be of any suitable size and configuration as is known in the art without affecting the overall concept of the invention, provided that it accomplishes the above-stated objectives. One of ordinary skill in the art will appreciate that the size, configuration, and material of the food slicer and shredder device 100 as shown in the FIGS. are for illustrative purposes only, and that many other sizes and shapes of the food slicer and shredder device 100 are well within the scope of the present disclosure. Although the dimensions of the food slicer and shredder device 100 are important design parameters for user convenience, the food slicer and shredder device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A food slicer and shredder device comprised of:
a top cover;
a blade attachment comprised of a plurality of blades; and
a housing.

2. The food slicer and shredder device of claim 1, wherein the plurality of blades is comprised of three blades.

3. The food slicer and shredder device of claim 1, wherein the plurality of blades is comprised of four blades.

4. The food slicer and shredder device of claim 1, wherein the top cover is comprised of a continuous opening that allows a user to insert a food item therethrough.

5. A food slicer and shredder device comprising:
a top cover;
a plurality of blades;
a housing;
a motor;
an internal wired circuit; and
a battery.

6. The food slicer and shredder device of claim 5, wherein the motor is comprised of a rotor.

7. The food slicer and shredder device of claim 5, wherein the plurality of blades are attached to a blade driving unit.

8. The food slicer and shredder device of claim 7, wherein the blade driving unit is used to rotate the plurality of blades and is in mechanical communication with the motor.

9. A food slicer and shredder device comprising:
a top cover having a discharge chute;
a plurality of blades;
a blade driving unit attached to the plurality of blades;
a housing;
a motor;
an internal wired circuit;
a battery; and
a plurality of control buttons.

10. The food slicer and shredder device of claim 9, wherein the plurality of blades is comprised of three equally spaced apart blades.

11. The food slicer and shredder device of claim 10 further comprising a middle glass cover attached to the top cover via a locking means.

12. The food slicer and shredder device of claim 11, wherein the locking means is a select one of a threaded connection, a snap, or a bayonet.

13. The food slicer and shredder device of claim 12, wherein a speed of rotation of the blade driving unit is controlled by one or more of the plurality of control buttons.

14. The food slicer and shredder device of claim 13, wherein the plurality of control buttons are comprised of a low-speed button, a medium-speed button, and a high-speed button.

15. The food slicer and shredder device of claim 14, wherein the plurality of control buttons further comprise an on/off button.

16. The food slicer and shredder device of claim 15, wherein the battery is rechargeable.

17. The food slicer and shredder device of claim 16, wherein the discharge chute has a continuous opening therein.

18. The food slicer and shredder device of claim 17 further comprising a blade connector positioned at a top end of the blade driving unit and configured to receive a blade attachment screw.

19. The food slicer and shredder device of claim 18, wherein the blade attachment screw is screwed into the blade connector.

20. The food slicer and shredder device of claim 19, wherein the blade driving unit is used to rotate the plurality of blades and is in mechanical communication with the motor.
